(19) United States
(12) Patent Application Publication
(10) Pub. No.: US 2025/0122054 A1
(43) Pub. Date: Apr. 17, 2025

(54) MANUAL CONTROLLER FOR INDIRECTLY CONTROLLING A FLUID-OPERATED LIFTING DEVICE, AND FLUID-OPERATED LIFTING DEVICE

(71) Applicant: J.D. Neuhaus Holding GmbH & Co. KG, Witten (DE)

(72) Inventor: Piotr KRUPNIK, Iserlohn (DE)

(21) Appl. No.: 18/684,501

(22) PCT Filed: Aug. 3, 2022
(86) PCT No.: PCT/EP2022/071863

§ 371 Date: Feb. 16, 2024

(30) Foreign Application Priority Data
Aug. 18, 2021 (DE) 10 2021 121 466.1

(51) Int. Cl. B66D 3/26; B66D 3/20

(52) U.S. Cl. CPC B66D 3/26; B66D 3/20

(57) ABSTRACT

The invention relates to a handheld controller for the indirect control of a fluid-operated hoist with at least one control fluid inlet and at least one control fluid outlet, a control valve arranged between the control fluid inlet and the control fluid outlet and a control element for actuating the control valve by a user. In order to provide a handheld controller for indirect control of a fluid-operated hoist and a fluid-operated hoist which have a particularly precise control characteristic adapted to the respective user and the respective usage situation and are thus perceived as particularly pleasant in use, it is provided that an input choke is arranged in at least one control fluid inlet in order to adjust the flow rate or the volume flow to the control valve and/or the control characteristic of the handheld controller.

The invention relates to a handheld controller for the indirect control of a fluid-operated hoist with at least one control fluid inlet and at least one control fluid outlet, a control valve arranged between the control fluid inlet and the control fluid outlet and a control element for actuating the control valve by a user. The invention also relates to a fluid-operated hoist.

Hoists are known in a variety of designs from the state of the art and are used in particular for the suspended lifting and moving of loads. For this purpose, the load is usually attached to a chain, cable or similar by means of a hook or other attachment and the chain or cable is moved by means of a drive. The drive comprises a motor, usually a gearbox and other components. In a fluid-operated hoist, the motor is driven hydraulically or pneumatically so that no electricity supply is required to drive the hoist.

To control the hoist, a handheld controller is typically provided, which in the case of a fluid-operated hoist is typically also fluid-operated and connected to the hoist via fluid lines. One advantage of these hoists is that only a supply of the operating fluid is required, but no electrical connection is necessary to operate the hoist. However, particularly long fluid lines of the handheld controller of a pneumatically operated hoist lead to a control delay due to the large internal volume of the fluid lines and therefore the control of such a hoist by a user is often perceived as imprecise and sluggish.

It is also known to control the motor of a hoist indirectly, whereby the working fluid, usually compressed air, is connected directly to a valve unit on the motor and control is achieved by means of a control fluid, usually also compressed air.

However, the control behavior and the control characteristics of the hoist are influenced by numerous factors and depend on the design of the handheld controller and the hoist as well as the respective installation situation at the operating site. Among other things, the control behavior and control characteristics are influenced by manufacturing tolerances of the handheld controller and the hoist, but also, for example, by the control fluid pressure applied and the length of the control fluid lines between the handheld controller and the hoist. Accordingly, several identical hoists can have different control behavior, which makes it difficult for a user to use the hoists precisely. In addition, the respective installation situation and other factors can result in control characteristics that the user may find unfavorable or uncomfortable for the respective application,

The invention is therefore based on the object of providing a handheld controller for indirect control of a fluid-operated hoist and a fluid-operated hoist which have particularly precise control characteristics adapted to the respective user and the respective usage situation and are thus perceived as particularly pleasant in use.

According to the invention, the object is solved by a handheld controller for indirect control of a fluid-operated hoist according to claim 1 and by a fluid-operated hoist according to claim 9. Advantageous further embodiments of the invention are given in the dependent claims.

The handheld controller according to the invention for the indirect control of a fluid-operated hoist has at least one control fluid inlet and at least one control fluid outlet, at least one control valve arranged between a control fluid inlet and a control fluid outlet and a control element for actuating the control valve by a user of the handheld controller, wherein an input choke is arranged in at least one control fluid inlet in order to be able to adjust or set the flow rate or the volume flow to the control valve and/or the control characteristic of the handheld controller.

Furthermore, the invention relates to a fluid-operated hoist with a fluid-operated motor, in particular a vane motor, for lifting and lowering a suspended load and/or for moving the hoist and/or for moving a load, and with a handheld controller according to the invention for indirectly controlling the fluid-operated motor,

A handheld controller is understood to be a assembly unit or a hand-held control unit for controlling at least some of the functions, in particular at least the lifting and lowering of loads and/or the movement of the hoist or a load, by a user, wherein the handheld controller is not arranged directly on the part of the hoist containing a motor and/or is connected to the hoist via one or more lines. Preferably, the handheld controller can be moved relative to the part of the hoist containing the motor, so that the hoist can be controlled from different positions. Furthermore, complete control of the hoist is preferably possible via the handheld controller.

In accordance with the invention, the handheld controller is provided for indirect control of the hoist. Indirect control means that the operating fluid or working fluid for driving the hoist does not flow through the handheld controller, but the handheld controller controls a valve unit for the operating fluid or working fluid, wherein the valve unit preferably is arranged in the area of the hoist and in particular in the part of the hoist containing the motor. Instead, the handheld controller is connected to the hoist via at least one control fluid line and, in particular, via a control fluid line for each valve of the valve unit of the hoist.

A fluid-operated hoist is basically a hoist for lifting and lowering loads, in which at least the motor intended for lifting and/or lowering the load is driven by means of an operating fluid. The hoist is preferably operated exclusively by means of the operating fluid and is particularly preferably a compressed air hoist or a pneumatic hoist. However, a design as a hydraulic hoist is also conceivable in principle. It is also preferred that the fluid-operated hoist does not have an external electrical connection, at least for the motor, and/or does not require an external power supply for operation.

The operating fluid, in particular the working fluid for directly driving the motor and/or the control fluid for controlling the valve unit by means of the handheld controller, can in principle be any liquid or gas. Although operation with a hydraulic operating fluid, in particular with hydraulic oil, is conceivable, purely pneumatic operation with any gas, for example air, nitrogen or a gas mixture, is preferred. The operating fluid is preferably compressed air, whereby compressed ambient air is particularly preferred. However, the compressed air can also have a different chemical composition and/or additives, such as oil, compared to the ambient air. The pressure of the compressed air is generally higher than the ambient or normal pressure and is preferably between 1.2 bar and 20 bar, particularly preferably between 1.5 bar and 15 bar, most preferably between 3 bar and 10 bar and particularly preferably between 4 bar and 8 bar.

In order to be able to supply a control fluid to the handheld controller, it has at least one control fluid inlet according to the invention. Preferably, the handheld controller has exactly one control fluid inlet for each control valve of the handheld controller and also preferably, each control fluid inlet is connected to exactly one control valve. The control fluid inlet can be designed in any shape and can, for example, have a standardized connection, such as for a compressed air hose.

Likewise, according to the invention, the handheld controller has at least one control fluid outlet which connects the handheld controller, and in particular the control valve, to the hoist, in particular the valve unit of the hoist. The handheld controller also preferably has a control fluid outlet for each control valve for connection to the hoist. The control fluid outlet can also be designed in any way and, for example, have a standardized connection, such as for a pneumatic line.

The at least one control valve of the handheld controller can in principle be designed in any way, whereby the control valve is arranged according to the invention between the control fluid inlet and the control fluid outlet in order to be able to completely block a flow of the control fluid from the control fluid inlet to the control fluid outlet and/or to be able to relieve the control fluid outlet. Preferably, however, the control valve is infinitely adjustable between the fully open and closed state. The control valve is also preferably a needle valve or a valve with an adjustable, in particular displaceable control piston and/or preloaded towards the closed position with a spring element.

The control element is basically a means accessible to the user for changing the position of at least one and preferably exactly one control valve. Particularly preferably, the control element enables a multi-stage or stepless or continuous change in the state of the control valve, especially preferably between a fully closed position and a fully open position. For this purpose, the control valve also preferably has a displaceable control piston, which can be displaced inside the valve directly or indirectly by means of the control element.

In order to be able to adjust the response behavior and the control characteristics of the handheld controller, an input choke is arranged in the area of the control fluid inlet and/or between the control fluid inlet and the control valve in accordance with the invention. The input choke is provided for regulating and/or setting and/or adapting the response and/or control behavior of the hoist. Alternatively or additionally, the input choke can also be used to correct the influence of manufacturing tolerances, in particular with regard to the response and/or control behavior of the hoist. Furthermore, alternatively or additionally, the input choke can also be used to customize the haptics of the controller and thus adapt the handheld controller to the individual user and/or the respective application. In addition, the input choke can be used to adapt the control characteristics to the control length of the hoist, i.e. the length of the control fluid lines between the handheld controller and the hoist can be taken into account, which can otherwise lead to an unfavorable change in the response behavior, especially with long lengths.

According to the invention, an input choke is arranged in at least one control fluid inlet and preferably exactly one input choke is arranged in each control fluid inlet or between each control fluid inlet and the associated control valve. The input choke is basically formed in order to be able to reduce, in particular, to adjust the flow of the control fluid through the control fluid inlet and/or to the control valve.

The motor of the fluid-operated hoist can initially be any fluid motor. Preferably, it is an expansion motor and particularly preferably a gas expansion motor. The motor is particularly preferably a pneumatically operated vane motor or a compressed air vane motor. Furthermore, the vane motor is preferably provided for driving the hoist and, in particular, a chain of the hoist. However, the motor can not only be a pneumatic motor, but can also be operated by means of a fluid, i.e. hydraulically.

In addition, the fluid-operated hoist can have any number of other assemblies and components, such as an electronic control and/or monitoring unit, a chain, a gearbox, a brake, in particular a fluid-operated brake, one or more shut-off valves and the valve unit for regulating the working fluid, in particular a valve unit with at least one valve for lifting and a second valve for lowering a load.

A preferred embodiment of the handheld controller according to the invention for indirect control of a fluid-operated hoist provides for the input choke to be arranged directly within a control fluid supply channel connecting the control fluid inlet to the control valve, which makes it particularly easy and direct to adjust the control behavior. The control fluid supply channel, and in particular a compressed air supply channel, is preferably provided for supplying control fluid, in particular control compressed air.

Furthermore, the input choke is preferably formed so that the control fluid supply can be variably adjusted, for which purpose the input choke preferably has an adjustable passage opening. The passage opening can have any shape and any cross-section, whereby the passage opening preferably has a circular cross-section in the open state and/or preferably an annular cross-section in the partially closed state. It is also preferred that the cross-sectional area of the passage opening can be permanently adjusted by a user, a technician and/or the manufacturer by means of the input choke. Accordingly, it is further preferred that the input choke is manually adjustable by a user of the handheld controller, a technician and/or the manufacturer and/or permanently retains the setting by the user, the technician and/or the manufacturer. In particular, it is preferred that the input choke is not an automatic choke which, for example, automatically sets the input pressure to a constant value or is regulated in some other way. Instead, the input choke is preferably intended exclusively for manual adjustment by a user, a technician and/or the manufacturer.

A preferred further development of the handheld controller according to the invention for indirect control of a fluid-operated hoist provides that the input choke is a needle valve and/or has a throttle screw for adjusting the input choke, in particular a passage opening. Preferably, the input choke is adjustable by means of a band tool and particularly preferably, the input choke and in particular a throttle screw has a hexagon socket for adjusting the input choke. In principle, however, a tool-free adjustment of the input choke is also conceivable, for which it can have a corresponding handle or control element.

In an advantageous embodiment of the handheld controller according to the invention for indirect control of a fluid-operated hoist, the input choke and in particular a throttle screw is accessible for adjustment from the outside and/or from the rear of the handheld controller, so that the input choke can be adjusted easily, in particular without having to dismantle and/or open other components of the handheld controller. In principle, however, it is also conceivable that the input choke is partially or completely arranged behind a protective cover, which can then preferably be opened without tools. The rear of the handheld controller is preferably the side opposite the control element(s) for actuating the control valve.

Furthermore, an embodiment of the handheld controller according to the invention for indirect control of a fluid-operated hoist is preferred in which the input choke, in particular a throttle screw and/or a needle valve, is locked in the set position by strongly pretensioning an O-ring which surrounds a component of the input choke, in particular a throttle screw and/or a needle valve. As an alternative to an O-ring, any other elastic element, in particular a sealing element, is also conceivable. In addition, the input choke, in particular a throttle screw and/or a needle valve, can also be fixed by means of a mechanical locking device.

Further preferred is a further development of the handheld controller according to the invention for indirect control of a fluid-operated hoist with a first control valve, in particular for activating a first operating mode of the hoist, for example for lifting a load and/or for moving the hoist or a load, and with at least one second control valve, in particular for activating a second operating mode of the hoist, for example for lowering a load and/or for moving the hoist or a load, wherein preferably an input choke is preferably arranged at the control fluid input of both control valves or each control valve, respectively, which enables the control characteristics of lifting and lowering to be coordinated and/or adapted in a particularly advantageous manner, so that optimum control curves can be obtained, for example with the same components in each case. In addition, each of the control valves can preferably be actuated by means of a control element.

Finally, an embodiment of the fluid-operated hoist is preferred in which the fluid-operated motor is operated by means of a working fluid and at least one valve unit is arranged on the hoist, in particular one valve unit per direction of movement, i.e. for lifting and lowering, to control the working fluid, whereby the valve unit on the hoist is controlled by means of the control fluid flowing through the handheld controller, whereby a particularly direct and instantaneous control is possible regardless of the length of the lines between the handheld controller and the hoist. Accordingly, the working fluid only flows through the hoist or the part of the hoist comprising the fluid-operated motor and/or not to or through the handheld controller. Furthermore, the handheld controller is preferably connected to the hoist or the part of the hoist comprising the fluid-operated motor via at least one and preferably two control fluid lines, while no working fluid line leads to the handheld controller,

The valve unit of the hoist comprises at least one, preferably exactly one valve for each control operation, in particular for lifting and for lowering, wherein each valve can particularly preferably be switched or controlled by means of a fluid pressure, in particular a gas pressure. Particularly preferably, each valve unit is formed by one or more valves and/or is operated exclusively pneumatically, whereby this furthermore preferably does not exclude any spring elements inside the valve unit, but particularly preferably only refers to operation from the outside.

An embodiment example of the handheld controller for a fluid-operated hoist according to the invention is explained in more detail below with reference to the drawings. The figures show:

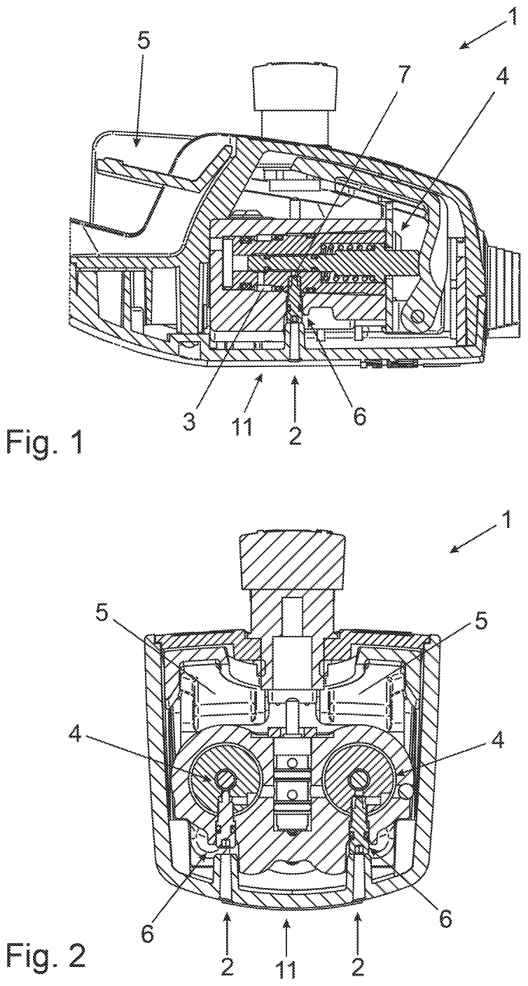

FIG. 1 a sectional drawing of the center section of a handheld controller for indirect control of a pneumatic hoist,

FIG. 2 a sectional view of the handheld controller rotated by 90° compared to FIG. 1,

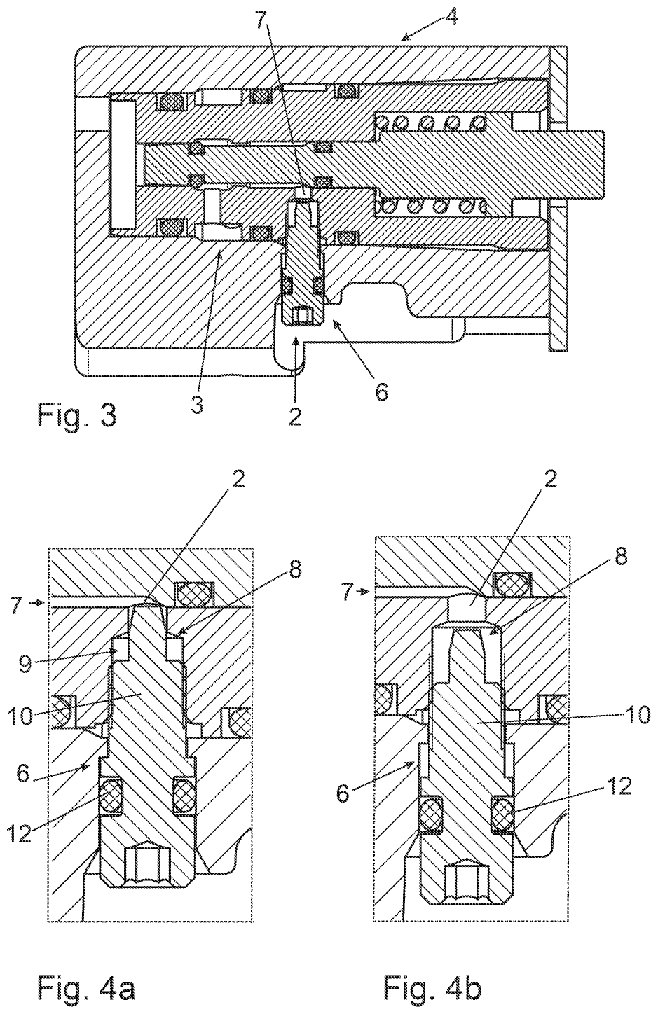

FIG. 3 an enlarged sectional view of a control valve of the handheld controller shown in FIG. 1,

FIG. 4a an enlarged sectional view of an input choke of the handheld controller shown in FIG. 1 with a fully closed input choke, and

FIG. 4b an enlarged sectional view of an input choke of the handheld controller shown in FIG. 1 with a fully open input choke.

A handheld controller 1 for indirect control of a pneumatic hoist, shown in sections in FIGS. 1 and 2, has two control elements 5 formed as levers, one control element 5 being provided for lifting a load by means of the hoist and the other control element 5 being provided for lowering the load. The hoist has a pneumatic vane motor that is driven by working air. A valve unit is arranged on the hoist, which has a valve for the working air for lifting and a valve for the working air for lowering. The valve unit is pneumatically controlled and can be controlled by means of control air as part of this indirect control,

To enable this control of the valve unit of the hoist by means of control air, the handheld controller 1 is connected to the valve unit via at least two control air lines. The control air lines are each connected to a control fluid outlet 3 of the handheld controller 1. In order to be able to supply the handheld controller 1 with the control fluid required for operation, the handheld controller 1 also has a control fluid inlet 2 in each case on the rear 11,

A control valve 4a, b is arranged between a control fluid inlet 2 and a control fluid outlet 3 of the handheld controller 1, whereby one control valve 4a is provided for lifting a load and the other control valve 4b is provided for lowering a load. The control valves 4a, b are each connected to a control element 5 and can be adjusted continuously between a fully open and a fully closed position by means of the control elements 5.

To enable the control characteristics of the handheld controller 1 and thus of the hoist to be adjusted, an input choke 6 is arranged inside a control fluid channel 7 between the control fluid inlet 2 and the respective control valve 4a, b, by means of which the quantity of control fluid passed through and supplied to the control valve 4a, b can be adjusted (see FIG. 3).

For this purpose, the input choke 6 forms a needle valve 9, whereby the tip of a throttle screw 10 of the input choke 6 determines the size or cross-section of a passage opening 8 in the control fluid channel 7 or to the control valve 4a, b. The throttle screw 10 has a thread and can be adjusted by means of a hexagon socket wrench in order to vary the size of the passage opening 8. The input choke 6 can be continuously adjusted between a fully open position, in which the input choke 6 does not reduce the influx of control fluid (see FIG. 4b), and a fully closed position, in which no more control fluid can flow to the control valve 4a, b (see FIG. 4a).

Furthermore, an O-ring 12 is arranged around the throttle screw 10, whereby the O-ring 12 is pretensioned by the throttle screw 10 in such a way that it fixes the throttle screw 10 in the position selected by a user. Accordingly, the input choke 6 maintains a constant position once it has been set.

### LIST OF REFERENCE SYMBOLS

1 Handheld controller
2 Control fluid inlet
3 Control fluid outlet
4a, b First and second control valve
5 Control element
6 Input choke
7 Control fluid channel
8 Diffuser opening
9 Needle valve
10 Throttle screw
11 Rear
12 O-ring

1. A handheld controller for indirect control of a fluid-operated hoist, comprising:
at least one control fluid inlet and at least one control fluid outlet,
a control valve arranged between the control fluid inlet and the control fluid outlet,
a control element (5) for actuating the control valve by a user, wherein
an input choke is arranged in at least one control fluid inlet in order to adjust the flow rate or the volume flow to the control valve and/or the control characteristic of the handheld controller.

2. The handheld controller for indirect control of a fluid-operated hoist according to claim 1, wherein the input choke is designed to be able to variably adjust the control fluid supply, for which purpose the input choke has an adjustable passage opening.

3. The handheld controller for indirect control of a fluid-operated hoist according to claim 1, wherein the input choke is arranged directly within a control fluid supply channel connecting the control fluid inlet to the control valve.

4. The handheld controller for indirect control of a fluid-operated hoist according to claim 1, wherein the input choke is manually adjustable by a user, a technician and/or the manufacturer of the handheld controller and/or permanently retains an adjustment by a user, a technician and/or the manufacturer.

5. The handheld controller for indirect control of a fluid-operated hoist according to claim 1, wherein the input choke is a needle valve and/or has a throttle screw for adjusting the input choke.

6. The handheld controller for indirect control of a fluid-operated hoist according to claim 1, wherein the input choke including a throttle screw is accessible from the outside and/or from the rear of the handheld controller for adjustment.

7. The handheld controller for indirect control of a fluid-operated hoist according to claim 1, wherein the input choke, including a throttle screw and/or a needle valve, is locked in the set position by strongly pretensioning a sealing element, in particular an O-ring, wherein the sealing element or the O-ring (12) surrounds a component of the input choke, including a throttle screw and/or a needle valve.

8. The handheld controller for indirect control of a fluid-operated hoist according to claim 1, characterized by a first control valve for a first operating mode for lifting a load, and by a second control valve for a second operating mode for lowering a load, wherein an input choke is arranged at the control fluid inlet of both control valves in each case.

9. A fluid-operated hoist, comprising:
a fluid-driven motor for lifting and lowering a suspended load and/or for moving the hoist and/or for moving a load, and
a handheld controller for indirectly controlling the fluid-operated motor according to claim 1.

10. The fluid-operated hoist according to claim 9, wherein the fluid-operated motor is operated by a working fluid and at least one valve unit is arranged on the hoist for controlling the working fluid, wherein the valve unit is controlled by the control fluid flowing through the handheld controller.
